(19) United States
(12) Patent Application Publication
(10) Pub. No.: US 2006/0119604 A1
(43) Pub. Date: Jun. 8, 2006

(54) Method and apparatus for accelerating the display of horizontal lines

(75) Inventors: Li Yao, Nanshan (CN); Wei Chen, Nanshan (CN)

Correspondence Address: SUGHRUE MION, PLLC, 401 Castro Street, Ste 220, Mountain View, CA, 94041-2007, US

(73) Assignee: SHENZHEN MINDRAY BIO-MEDICAL ELECTRONICS CO. LTD., Nanshan (CN)

(21) Appl. No.: 11/293,349

(22) Filed: Dec. 2, 2005

(30) Foreign Application Priority Data
Dec. 3, 2004 (CN) 200410077288.9

(51) Int. Cl. G09G 5/39

(52) U.S. Cl. 345/531

(57) ABSTRACT

The present invention relates to a method and apparatus for accelerating the display of horizontal lines used in an embedded system. The embedded system comprising a CPU (Central Processing Unit), a display terminal, a video memory for storing one or more display data, each data corresponds to a respective pixel on the display terminal, and a display-driving circuit for generating logic signals to read the display data from the video memory and delivering the display data to the display terminal for display, the apparatus for accelerating the display of horizontal lines comprising: a video memory controller, coupled to the CPU, the display-driving circuit and the video memory, for receiving from the CPU all request signals for performing reading and writing operations with the video memory, generating respective logic signals in response to the request signals and controlling the operations of reading data from or writing data into the video memory; a FIFO (First-In First-Out) buffer, coupled to a CPU bus, for, when the CPU provides an instruction for performing an operation of writing data into the video memory, buffering a control word sent by the CPU to the video memory controller, and the starting address for writing data into the video memory and the data to be written; and a line-accelerating register, comprising a length register for registering a line length value from the CPU and a line-accelerating flag for indicating an instruction for displaying a point or displaying a line from the CPU, wherein the FIFO buffer is also coupled to the output of the line-accelerating register and the FIFO buffer outputs a signal indicating whether it's empty or not to the video memory controller.

### FIELD OF THE INVENTION

The present invention relates to the field of display techniques, and more particularly, to method and apparatus for accelerating the display of horizontal lines.

### BACKGROUND OF THE INVENTION

Currently, a plurality of embedded systems establish human-machine interface by drawing on the display device interface elements such as menu, message box, dialogue box, status bar or the like. These embedded systems generally comprise a CPU (Central Processing Unit), a display terminal, a video memory for storing display data, a display-driving circuit and etc. To display a complex interface, these embedded systems typically use a standalone video memory in place of the main memory, to store the pixel array information to be displayed on the display screen, so as to improve the utilization of the CPU (Central Processing Unit) and the main memory. The displaying principle of these embedded systems is as follows: the display terminal, such as CRT (Cathode Ray Tube) or LCD (Liquid Crystal Display), is mapped into a two-dimensional array. Each pixel on the display terminal corresponds to a unit in the two-dimensional array and the value of this unit is the color code of its corresponding pixel. The vertical and horizontal coordinates of a pixel are the two indexes in the two-dimensional array, that is, a pixel with coordinates of (x, y) on the display terminal corresponds to a unit A (x, y) in the two-dimensional array. The video memory is used as a physical device for storing the two-dimensional array. In this way, each piece of data in the video memory corresponds to a respective point on the display device. Whenever the CPU writes a piece of data into the video memory, a point is displayed on the display device. The display-driving circuit reads the display data from the video memory automatically and displays it at a correct position on the display device.

Currently, a plurality of embedded systems implement the display-driving circuit by using FPGA (Field Programmable Gate Array) because it has advantages such as low cost, high flexibility and good extensibility, which greatly enhances the system integrated level and reduces the system cost. However, most of the functionalities of these display-driving circuits are simple relatively, without providing acceleration capability. For example, the CPU has to write a piece of data into the video memory to display a point, and thus has to write n pieces of data into the display consecutively so as to draw a line with length of n. Most display elements used in the human-machine interface, such as menu, dialogue box or the like, may be divided into points, lines and rectangles, that is, the background, outer box and the like are composed of rectangles with the same color, while the character, icon or the like inside are formed by arranging and combining points with different colors. If simple graphics units, such as the background and outer box, are also displayed with the method for displaying points, undoubtedly it will cause great waste of CPU resources and thus degrade the system performance.

In view of the above problem, current computer display techniques employ a display-accelerating method by combining software and hardware, in particularly, providing a display card between the CPU and the monitor, wherein the display card comprises a GPU (Graphics Processing Unit) including a number of commonly used modules for basic graphics programs; receiving various drawing instructions from the device interface and drawing an image by executing the instructions, and then writing the image data into the video memory. However, such operations and management performed by the display card with the video memory can't be applied to the embedded systems directly, because above display techniques for the video memory are developed based on operating systems and hardware for computers. With regard to an embedded system having a high-integrated architecture and simple function, there is therefore a need in the art to develop an apparatus and method for the display devices of embedded systems, so as to reduce overhead for the CPU resources.

### SUMMARY OF THE INVENTION

An object of the invention is to provide an apparatus with a simple structure used in an embedded system, for accelerating the display of horizontal lines and thus accelerating the display of dialogue boxes or the like in the human-machine interface, which may improve the processing efficiency of the embedded system.

The other object of the invention is to provide a display-accelerating method using above apparatus used in an embedded system, which may improve the processing efficiency of the embedded system.

To achieve the above object, the technical solution of the invention is to provide a video memory controller in an embedded system to manage all access operations for the video memory. By decomposing a complex image into a set of horizontal lines, the CPU in the embedded system provides the values of the starting address, length and color for each horizontal line to the video memory controller. Then video memory controller writes the data for all pixels on each line into the video memory.

In one aspect of the invention, there is provided with an apparatus for accelerating the display of horizontal lines used in an embedded system, the embedded system comprising a CPU (Central Processing Unit), a display terminal, a video memory for storing display data, each piece of which corresponds to a respective pixel on the display terminal, and a display-driving circuit for generating logic signals to read the display data from the video memory and delivering the display data to the display terminal for display. The apparatus for accelerating the display of horizontal lines comprising: a video memory controller, coupled to the CPU, the display-driving circuit and the video memory, being operable to receive from the CPU all request signals for performing reading and writing operations with the video memory, generate their respective logic signals in response to the request signals and control the operations of reading data from or writing data into the video memory; a FIFO (First-In First-Out) buffer, with its input coupled to the CPU bus so as to buffer a control word sent by the CPU to the video memory controller when the CPU issues an instruction for performing an operation of writing data into the video memory, the starting address for writing data into the video memory and the data to be written; and a line-accelerating register, comprising a length register for registering a line length value from the CPU and a line-accelerating flag for indicating an instruction for displaying a point or displaying a line from the CPU, wherein the FIFO buffer is coupled to the output of the line-accelerating register and outputs a signal indicating whether it's empty or not to the video memory controller.

In one embodiment, the video memory is a SDRAM (Synchronous Dynamic Random Access Memory) and the apparatus for accelerating the display of horizontal lines used in an embedded system further comprises a timing-refreshing unit coupled to the video memory controller, for generating a request signal for performing a refreshing operation to the video memory at a timing, sending the request signal to the video memory controller and withdrawing the request signal according to a response signal from the video memory controller. In one embodiment, the display-driving circuit comprises a DPRAM for receiving data read by the video memory. The DPRAM comprising at least two pages.

In one embodiment, each of the video memory controller, the FIFO buffer, the line-accelerating register is implemented in FPGA or ASIC.

In another aspect of the invention, there is provided with a method for accelerating the display of horizontal lines by using above apparatus for accelerating the display of horizontal lines used in an embedded system, the embedded system comprising a CPU (Central Processing Unit), a display terminal, a video memory for storing display data, each piece of which corresponds to a respective pixel on the display terminal, and a display-driving circuit for generating logic signals to read the display data from the video memory and delivering the display data to the display terminal for display, the apparatus for accelerating the display of horizontal lines comprising a video memory controller, coupled to the CPU, the display-driving circuit and the video memory, for receiving from the CPU all request signals for performing reading and writing operations to the video memory, generating respective logic signals in response to the request signals and controlling the operations of reading data from or writing data into the video memory; a FIFO (First-In First-Out) buffer, with its input coupled to the CPU bus so as to buffer a control word sent by the CPU to the video memory controller when the CPU provides an instruction for performing an operation of writing data into the video memory, and the starting address for writing data into the video memory and the data to be written; and a line-accelerating register, comprising a length register for registering a line length value from the CPU and a line-accelerating flag for indicating an instruction for displaying a point or displaying a line from the CPU, wherein the FIFO buffer is coupled to the output of the line-accelerating register and outputs a signal indicating whether it's empty or not to the video memory controller, the method comprising steps of:

a). generating by the display-driving circuit a valid rdsdram signal according to the timing set by the system and outputting it to the video memory controller;

b). providing by the CPU to the FIFO buffer the starting address for writing data into the video memory and the data to be written and providing the control word by the CPU to the FIFO buffer via the line-accelerating register when the CPU generates an instruction for performing an operation of writing data into the video memory;

c). generating a valid fifo₁₃ nemp signal and providing it to the video memory controller by the FIFO buffer when the data which has not been read by the video memory controller is present in the FIFO buffer; and

d). responding to the video memory by the video memory controller as follows when the video memory controller receives or detects the valid rdsdrm signal and the valid fifo_nemp signal,

(1) in case of the valid rdsdrm signal, controlling by the video memory controller the operation of reading data from the video memory according to a reading address generated by an address generator, and providing by the video memory controller a response signal so that the display-driving circuit withdraws the validity of the rdsdrm signal after the reading operation is completed; and

(2) in case of the valid fifo_nemp signal, reading by the video memory controller the FIFO buffer and controlling the operation of writing data into the video memory according to the read address, data and control word.

In one embodiment, the video memory is a SDRAM (Synchronous Dynamic Random Access Memory) and the apparatus for accelerating the display of horizontal lines used an embedded system further comprises a timing-refreshing unit, coupled to the video memory controller, for generating a request signal for performing a refreshing operation to the video memory at a timing, sending the request signal to the video memory controller and withdrawing the request signal according to a response signal from the video memory controller. The method further comprising steps of: generating by the timing-refreshing unit a valid ref_begin signal and providing it to the video memory controller. The video memory controller further responds to the video memory as follows upon receipt or detection of the valid ref_begin signal, the valid rdsdrm signal and the valid fifo_nemp signal: (3) in case of the valid ref_begin signal, controlling a automatic refreshing operation to the video memory by the video memory controller and after the automatic refreshing operation is completed, providing by the video memory controller a response signal so that the timing-refreshing unit withdraws the validity of the ref_begin signal.

Wherein the steps a) to d) are not necessarily performed in said priority order.

In one embodiment, the step b) comprises steps of: (b1) writing by the CPU the control word into the line-accelerating register when the instruction for the operation of writing data into the video memory generated by the CPU indicates to draw a line, the control word including the line-accelerating flag (=1) and the line length value; (b2) clearing the line-accelerating flag to zero automatically each time the step (b1) is completed, so that it is not necessary to write the control word to the line-accelerating register when the instruction for the operation of writing data into the video memory generated by the CPU indicates to draw a pixel, wherein the video memory controller performs the following operations according to the line-accelerating flag in the control word at the step d) on receipt or detection of the valid fifo_nemp signal:

(I). writing the data for drawing a point into the video memory according to the starting address and data when the line-accelerating flag is 0; and

(II). writing the data for drawing a line into the video memory according to the starting address, data and line length value when the line-accelerating flag is 1, that is, writing a plurality of identical data in the range of the line length value into the video memory consecutively.

In one embodiment, the video memory controller responds to the valid ref_begin signal, the valid rdsdrm signal and the valid fifo_nemp signal according to said priority order.

In one embodiment, the operation of reading data from or writing data into the video memory at the step d) is performed by activating a page burst access to the SDRAM as the video memory.

Compared with prior arts, the invention has the advantageous effects of saving CPU resources for embedded systems greatly and improving the efficiency for the CPU in processing display tasks by providing above apparatus and method for accelerating the display of horizontal lines, thus to improve the utilization of embedded systems and speed up the display of the human-machine of the embedded system.

### BRIEF DESCRIPTION OF THE DRAWINGS

FIG. 1 is a block diagram illustrating an apparatus for accelerating the display of horizontal lines used in an embedded system according to an embodiment of the invention.

FIG. 2 is a block diagram illustrating an apparatus for accelerating the display of horizontal lines used in an embedded system according to another embodiment of the invention.

FIG. 3 schematically shows the operation that the CPU instructs to draw a point.

FIG. 4 and FIG. 5 schematically show the operations that the CPU instructs to draw a line.

FIG. 6 is a flow chart illustrating a method for accelerating the display of horizontal lines used for an embedded system according to an embodiment of the invention.

FIG. 7 is a flow chart illustrating a method for accelerating the display of horizontal lines used for an embedded system according to another embodiment of the invention.

FIG. 8 schematically shows the logical-states transitions of the video memory controller according to the invention.

### DETAILED DESCRIPTION OF THE PREFERRED EMBODIMENTS

Detailed descriptions will be given below to the invention with reference to preferred embodiments illustrated in accompanying drawings.

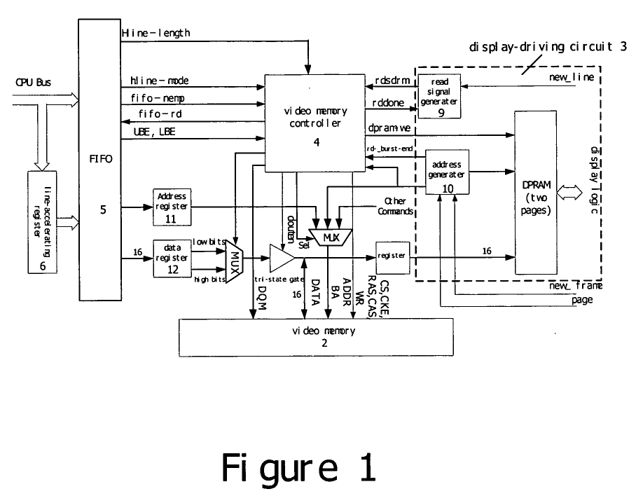

FIG. 1 illustrates an apparatus 1 for accelerating the display of horizontal lines used in an embedded system according to a preferred embodiment of the invention.

As shown in FIG. 1, the apparatus 1 is for use in an embedded system and the embedded system comprises: a CPU (Central Processing Unit) (not shown) as the control center of the system; a display terminal (not shown), which may be a CRT (Cathode Ray Tube) or LCD (Liquid Crystal Display); a video memory 2 for storing display data, each data corresponds to a respective pixel on the display terminal; and a display-driving circuit 3 for generating logic signals to read the display data from the video memory and delivering the read display data to the display terminal for display. The apparatus 1 further comprises a video memory controller 4, coupled to the display-driving circuit 3 and the video memory 2, being operable to receive all request signals for performing operations of reading data from and writing data into the video memory 2, generate respective logic signals in response to the request signals and control the operations of reading data from or writing data into the video memory 2; and a FIFO (First-In First-Out) buffer 5, coupled to the CPU via a CPU bus, being operable to buffer a control word sent by the CPU to the video memory controller 4 when the CPU issues an instruction for performing an operation of writing data into the video memory 4, and the starting address for writing data into the video memory 4 and the data to be written.

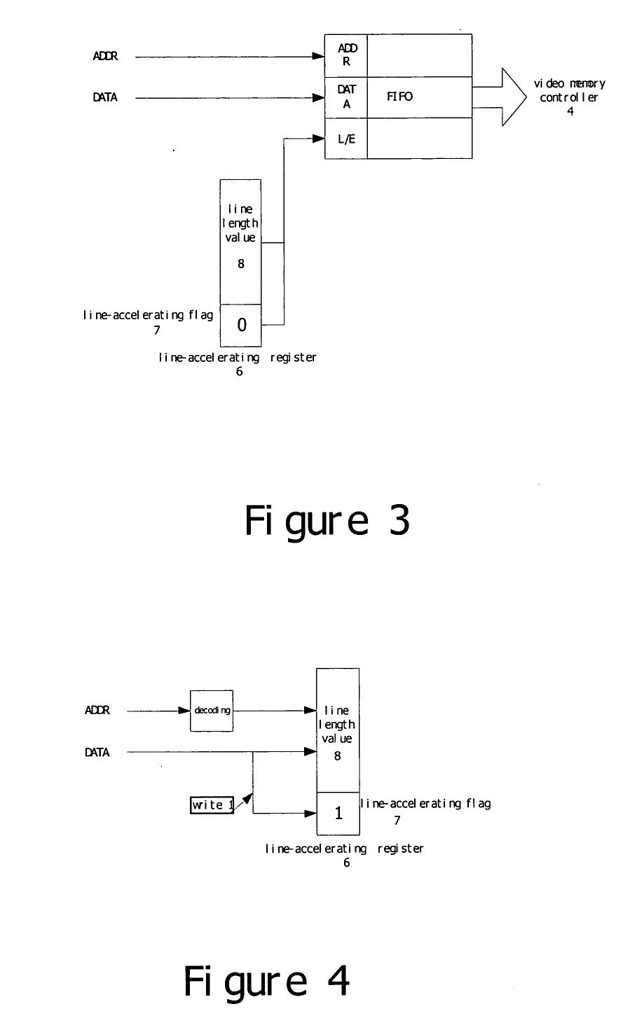

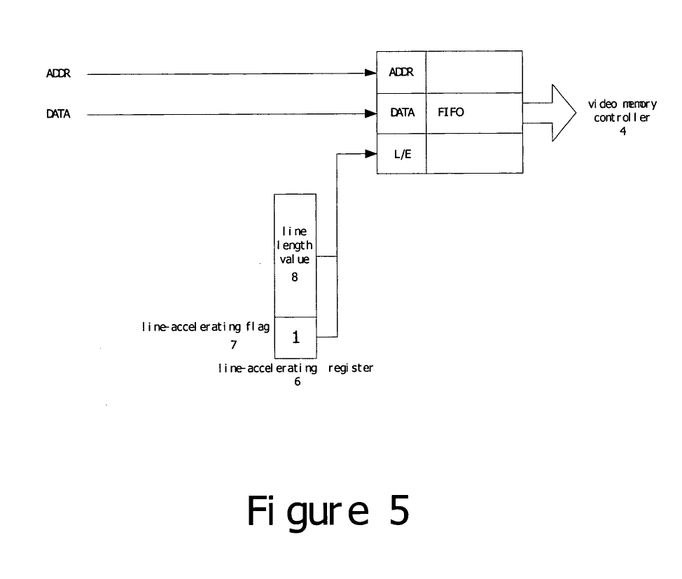

The apparatus 1 further comprises a line-accelerating register 6, with its input coupled to the CPU via the CPU bus and its output coupled to the FIFO buffer 5, being operable to buffer the instructions (i.e. control words) for drawing a line or drawing a point. As shown in FIG. 4, the line-accelerating register 6 comprises a line-accelerating flag 7 and a length register 8. Whenever the CPU issues an instruction for drawing a point or a line, it selects the line-accelerating register 6 through address decoding and writes the line-accelerating flag and the line length value thereto. As shown in FIG. 5, in the next bus period, the CPU performs an operation of writing data into the video memory 2 (i.e. writing the starting address ADDR and the data DATA into the FIFO buffer 5), meanwhile, the line-accelerating flag and the line length value in the line-accelerating register 6 are written into the FIFO buffer 6 as a control word. The starting address is the address where the starting point of the line is mapped into the video memory. The line-accelerating flag is used to distinguish operations of drawing a point or a line. For example, 0 indicates to draw a point and 1 indicates to draw a line. In this manner, when the line-accelerating flag is 0, data in the length register 8 is meaningless. The operation of drawing a point may be set as the default status. When the CPU writes the starting address and the data into the FIFO buffer 5, the line-accelerating flag in the line-accelerating register 6 will be cleared to zero automatically, so that it's of no necessity to write the line-accelerating flag and the line length value into the line-accelerating register 6 when an instruction for writing data into the video memory 2 generated by the CPU indicates to draw a point. As shown in FIG. 3, when the CPU provides an instruction to draw a point, the CPU may write data directly into the video memory 2 (i.e., write the address ADDR and the data DATA into the FIFO buffer) with the line-accelerating flag (=0) being written into the FIFO buffer 5 automatically.

After the video memory controller 4 reads the control word, the starting address ADDR and the data DATA from the FIFO buffer 5, it outputs the data DATA to the video memory 2 according to the obtained address ADDR. Specifically, the video memory controller 4 activates an operation of writing a single word, to write an 8-bit or 16-bit data into the corresponding addresses in the video memory 2, if the line-accelerating flag in the control word is 0. On the other hand, if the line-accelerating flag in the control word is 1, the video memory controller 4 activates an operation of a page burst writing, to write a plurality of same data into the corresponding addresses of the video memory 4 consecutively, and controls termination of the writing operation according to the line length value in the control word. The efficiency may be maximized by drawing lines in such a page burst writing way.

The display-driving circuit 3 in this embodiment comprises a read signal generator 9 and an address generator 10 for counting the read addresses automatically and generating address signals. The display-driving circuit 3 reads data from the video memory 2 in such a logical control that the display-driving circuit 3 generates a new_line signal (for requesting a line of new display data) according to a timing set by the system and upon detection of the validity of the new_line signal, the read signal generator 9 generates a valid rdsdrm (request for reading data from the video memory) to be sent to the video memory controller 4 immediately. The video memory controller 4 responds to the valid rdsdrm signal by controlling the reading of the display data in a corresponding region of the video memory 2 according to the address signals generated by the address generator and providing it to the display-driving circuit 3. The display-driving circuit 3 outputs the received display data to the display terminal for display. After the reading operation is completed, the video memory controller 4 sends an rddone signal to notify the read signal generator 7 of withdrawing the validity of the rdsdrm signal.

In this embodiment, the video memory 2 is a SDRAM (Synchronous Dynamic RAM) whose reading and writing speed mainly depend on the requirement for the display data bandwidth by the display terminal. In this embodiment, the operating clock of the video memory 2 is set two times the display clock and the system performance is improved greatly.

In this embodiment, the depth of the FIFO buffer 5 may be set large enough and output a fifo_nemp signal to the video memory controller 4, indicating whether the FIFO buffer 5 is empty or not, thus having a buffer scheduling function. When the CPU prepares to write data into the video memory 2, it is very likely that the video memory 2 is performing a reading operation. At this time, the CPU may store into the FIFO buffer 5 the control word, starting address and data for writing into the video memory directly without waiting for the completion of the reading operation of the video memory 2. Each time the CPU writes into the FIFO buffer 5, the internal pointer of the FIFO buffer 5 will increase by 1 automatically. Each time the video memory controller reads from the FIFO buffer 5, the internal pointer of the FIFO buffer 5 will decrease by 1 automatically. Techniques related to implementing the FIFO buffer 5 are well known and the description thereof is omitted. In this way, the video memory 2 is transparent to the CPU and the CPU bus won't be suspended due to contending the video memory from other devices, which improves the system efficiency.

As shown in FIG. 1, the apparatus 1 may further comprise an address register 11 and a data register 12 between the FIFO buffer 5 and the video memory 2, so that a set of addresses, data and control words may be read into the address register 11, the data register 13 and the video memory controller 4 respectively during the operation of writing data into the video memory 2, and at the same time, the internal count of the FIFO buffer 5 decreases by 1 automatically. Then, the address register 12 and the data register 13 output the received address and data to the video memory 2, respectively.

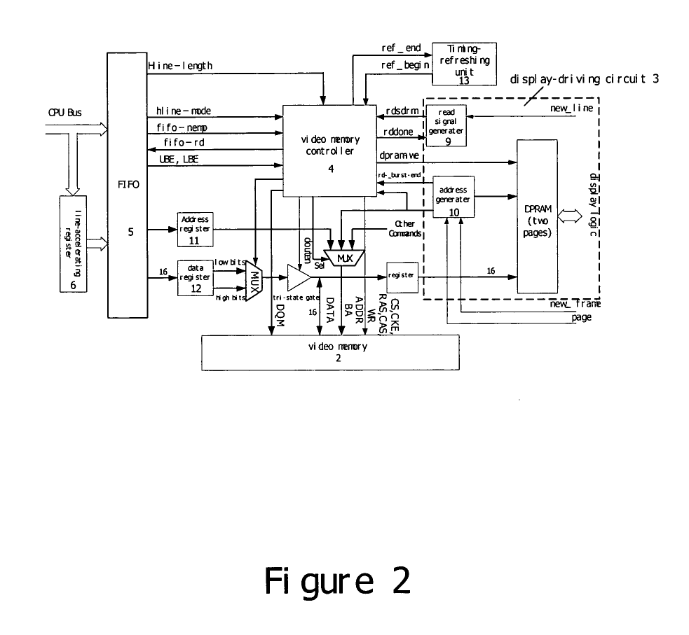

FIG. 2 illustrates an apparatus 1 for accelerating the display of horizontal lines used in an embedded system according to another embodiment of the invention. The configuration of the apparatus 1 shown in FIG. 2 is similar to that of the apparatus 1 shown in FIG. 1. Due to the volatility of the SDRAM as the video memory 2 for storing data, the apparatus 1 in this embodiment further comprises a timing-refreshing unit 12, for generating a request signal ref_begin for performing a refreshing operation to the video memory 2 at a timing and sending the request signal to the video memory controller 4. When the video memory controller 4 receives the valid ref_begin signal, it will perform a automatic refreshing operation to the video memory 2 and outputs a valid ref_end signal to the timing-refreshing unit 9, to indicate that it has responded to the refreshment request, so that the timing-refreshing unit 9 will withdraw the validity of the ref_begin signal.

With regard to the display-accelerating apparatus 1 used in an embedded systems in the above two embodiments, the FIFO buffer 5, the video memory 2 and the video memory controller 4 are the most important parts for the processing and the video memory controller 4 is responsible for managing all access operations to the video memory 2.

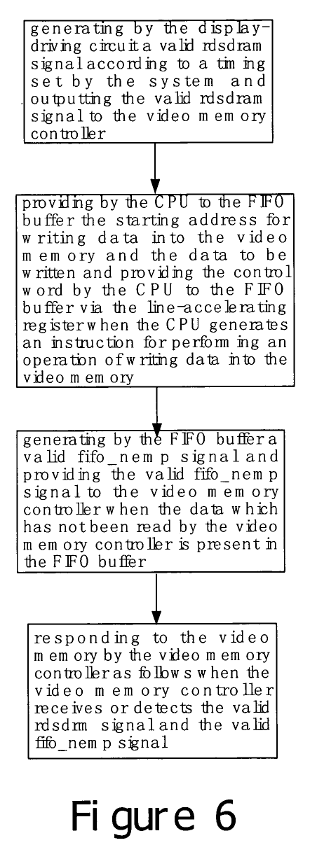

FIG. 6 illustrates a method, used for an embedded system, for accelerating the display of horizontal lines using the apparatus 1 shown in the embodiment of FIG. 1, the method comprising steps of:

a). generating a valid rdsdram signal by the display-driving circuit 3 according to a timing set by the embedded system and outputting the valid rdsdram signal to the video memory controller 4;

b). providing by the CPU to the FIFO buffer 5 the starting address for writing data into the video memory 2 and the data to be written, and providing the control word by the CPU to the FIFO buffer 5 via the line-accelerating register 6 when the CPU generates an instruction for performing an operation of writing data into the video memory 2;

c). generating a valid fifo_nemp signal by the FIFO buffer 5 and providing it to the video memory controller 4 when the data which has not been read by the video memory controller 4 is present in the FIFO buffer 5; and

d). responding by the video memory controller 4 to the video memory 2 as follows when the video memory controller 4 receives the valid rdsdrm signal and the valid fifo_nemp signal:

(1). in case of the valid rdsdrm signal, controlling by the video memory controller 4 the operation of reading data from the video memory 2 according to a reading address generated by an address generator 10, and after the reading operation is completed, providing by the video memory controller 4 a response signal so that the display-driving circuit 3 withdraws the validity of the rdsdrm signal; and

(2). in case of the valid fifo_nemp signal, reading by the video memory controller 4 the address, the data and the control word from the FIFO buffer 5 and controlling the operation of writing data into the video memory according to the read address, data and control word.

In the method of this embodiment, the steps a) to d) are not necessarily performed in said priority order.

Wherein, the step b) comprises steps of: (b1) writing the control word into the line-accelerating register 6 by the CPU when the instruction for writing data into the video memory 2 generated by the CPU indicates to draw a line, the control word including the line-accelerating flag (=1) and the line length value; (b2) clearing the line-accelerating flag to zero automatically each time the step (b1) is completed, so that it is not necessary to write the control word into the line-accelerating register 6 when the instruction for writing data into the video memory 2 generated by the CPU indicates to draw a pixel, wherein when the video memory controller 4 receives the valid fifo_nemp signal at the step d), the video memory controller 4 performs the following operations of writing data into the video memory 2 according to the line-accelerating flag in the control word:

(I). writing the data for drawing a point into the video memory 2 according to the starting address and data when the line-accelerating flag is 0; and

(II). writing the data for drawing a line into the video memory 2 according to the starting address, data and line length value when the line-accelerating flag is 1, that is, writing a plurality of identical data in the range of the line length value into the video memory 2 consecutively.

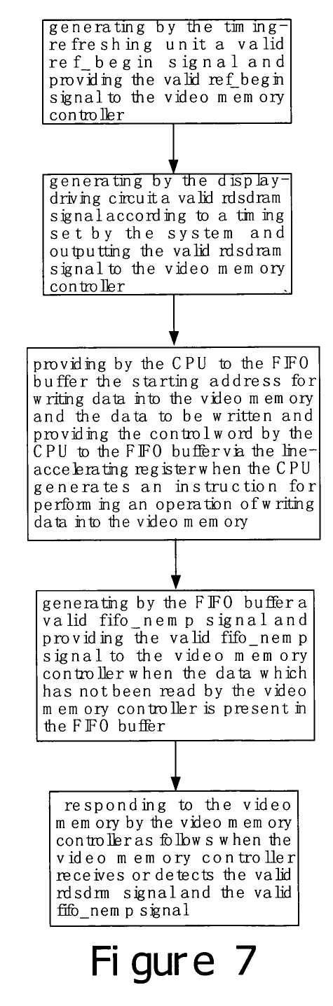

FIG. 7 illustrates a method, used for an embedded system, for accelerating the display of horizontal lines using the apparatus of the embodiment of FIG. 2, the method comprising steps of:

a). generatiing a valid ref_begin signal by the timing-refreshing unit 9 at a timing and sending it to the video memory controller 4;

b). generating by the display-driving circuit 3 a valid rdsdram signal according to the timing set by the embedded system and outputting it to the video memory controller 4;

c). providing by the CPU to the FIFO buffer 5 the starting address for writing data into the video memory and the data to be written, and providing by the CPU the control word to the FIFO buffer 5 via the line-accelerating register 6 when the CPU generates an instruction for performing an operation of writing data into the video memory 2;

d). generating a valid fifo_nemp signal by the FIFO buffer 5 and providing it to the video memory controller 4 when the data which has not been read by the video memory controller 4 is present in the FIFO buffer 5; and

e). responding by the video memory controller 4 to the video memory as follows when the video memory controller 4 receives the valid ref_begin signal, the valid rdsdrm signal and the valid fifo_nemp signal:

(1) in case of the valid ref_begin signal, controlling automatic refreshing operation to the video memory by the video memory controller 4 and providing a response signal so that the timing-refreshing unit 9 withdraws the validity of the ref_begin signal after the automatic refreshing operation is completed;

(2) in case of the valid rdsdrm signal, controlling by the video memory controller 4 the operation of reading data from the video memory 2 according to a read address generated by an address generator 10, and providing by the video memory controller 4 a response signal so that the display-driving circuit 3 withdraws the validity of the rdsdrm signal after the reading operation is completed; and

(3) in case of the valid fifo_nemp signal, reading by the video memory controller 4 the address, the data and the control word from the FIFO buffer 5and controlling the operation of writing data into the video memory 2 according to the read address, data and control word.

In the method of the embodiment, the steps a) to e) are not necessarily performed in said priority order. The step c) comprises steps of: (c1) writing the control word by the CPU to the line-accelerating register 6 when the instruction for writing data into the video memory 2 generated by the CPU indicates to draw a line, the control word including the line-accelerating flag (=1) and the line length value; (c2) clearing the line-accelerating flag to zero automatically each time the step (c1) is completed, so that it is not necessary to write the control word to the line-accelerating register 6 when the instruction for writing data into the video memory 2 generated by the CPU indicates to draw a pixel, wherein when the video memory controller 4 receives the valid fifo_nemp signal at the step e), the video memory controller 4 performs the following operations of writing data into the video memory 2 according to the line-accelerating flag in the control word:

(I). writing the data for drawing a point into the video memory 2 according to the starting address and data when the line-accelerating flag is 0; and

(II). writing the data for drawing a line into the video memory 2 according to the starting address, data and line length value when the line-accelerating flag is 1, that is, writing a plurality of identical data in the range of the line length value into the video memory 2 consecutively.

In the methods of the above two embodiments, the video memory 2 is a SDRAM. The operation of reading data from or writing data into the video memory 2 is performed by activating a page burst access to the SDRAM. All operations to the SDRAM are implemented by a series of commands output from the video memory controller 4. For each operation, the video memory controller 4 will take a few periods to provide control commands for the SDRAM to enter into READY state and the SDRAM accelerates data writing or reading in a page burst access way. That is, after entry into READY state, the SDRAM reads or writes data of one page (256 bits in the embodiment of the invention) consecutively at a clock frequency, the ratio of the effective time for reading/writing data to the total time consumption in such a page burst access way being much higher than that for a single-word manner or a small burst way, and accordingly efficiency for reading/writing the video memory is maximized. For a display with higher resolution, for example, the display data in on line on the display screen has 1024 words, the video memory controller 4 may trigger 4 reading operations consecutively when the video memory circuit 3 outputs a request to read data from the video memory 2, and read a page of 256 words each time, so as to take full advantage of the high efficiency of the page burst access way.

In the methods of the above two embodiments, the video memory controller 4 responds to the valid ref_begin signal, the valid rdsdrm signal and the valid fifo_nemp signal according to said priority order. The ref_begin signal (corresponding to the refreshing operation) has the highest priority, because the SDRAM needs to refresh its internal storage unit at certain time intervals, in order to avoid error or loss in data storage. A refreshing operation won't occupy a too long period and won't affect the timely response to requests for other operations. The display-driving circuit 3 has a second highest priority to read data from the video memory (rdsdrm signal) and the CPU has a lowest priority to write data into the video memory 2 (fifo_nemp signal).

The operational clock frequency of the SDRAM may be very high, and commonly is set as two times of the operational clock frequency of the display-driving circuit 2. To concert the contentions from the valid ref_begin signal, the valid rdsdrm signal and the valid fifo_nemp signal so that the display-driving circuit can always acquire data in time, the display-driving circuit 2 of the invention further comprises a Dual Port RAM (DPRAM) 10 with buffering functionality, to receive data read from the SDRAM (the video memory 2). The DPRAM 10 includes at least two pages, each page buffering data of 1024 words, the data of one page being used by the display-driving circuit 3 currently and the data of the other page being pre-stored to be used in the next line display period, data of the two pages being used alternatively. In this way, since the time used by the video memory controller 4 to store data into the DPRAM is a half of time used by the display-driving circuit 3 to read data from the DPRAM 10, the video memory controller 4 can always store the requested next line of data into DPRAM 10 in time and save 50% time which may be used to complete the operation of writing data into the video memory.

With the method and apparatus according to the above embodiments of the invention, any requests for reading/writing operations to the video memory may be performed efficiently and timely, thus preventing the degradation in efficiency due to contentions between the reading and writing

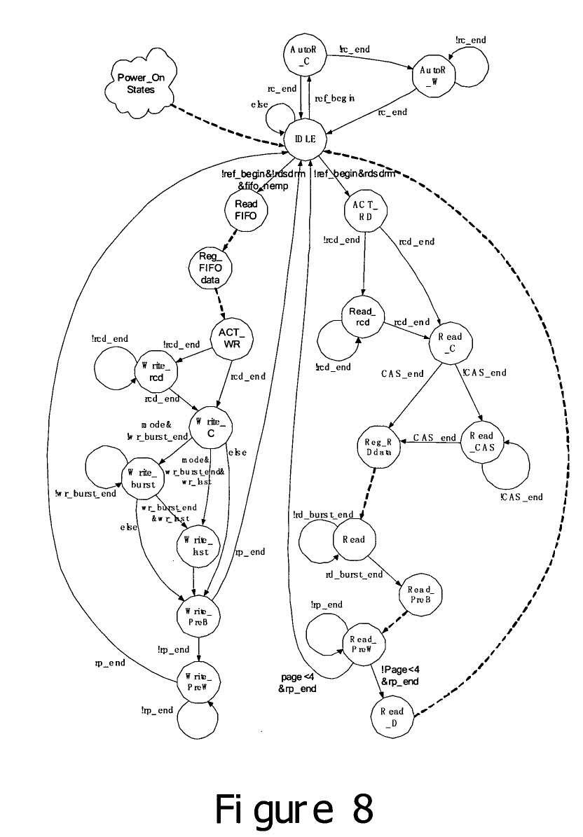

More specifically, the video memory controller 4 starts from an IDLE state, and provides a responses to the valid ref_begin signal, the valid rdsdrm signal and the valid fifo_nemp signal, that is, the processes for performing each operation to the video memory in the above steps, may be further illustrated by the logical states transitions of the video memory controller 4 as shown in FIG. 8.

As shown in FIG. 8, generally, the video memory controller 4 waits in IDLE state for occurrence of the requests for accessing the video memory 2. The timing-refreshing unit 9, the display-driving circuit 3 and the CPU work independently. After the valid ref_begin signal, valid rdsdrm signal and valid fifo_nemp signal are generated, the video memory controller 4 begins to operate, determines the type of the signals to be responded and then enters the corresponding operation to the video memory, specifically as:

(1) Automatic refreshing operation: activated by a valid ref_begin signal. The video memory controller 4 enters into AutoR_C state (Automatic Refreshment, a self-defined state name), and issues a an automatic refreshment command to the SDRAM.

Upon expiration of the tRC (time for a RAS period, RAS denoting for Row Address Strobe) timing, the video memory controller 4 returns to the IDLE state and issues a ref_end signal, to notify the timing-refreshing unit 9 of withdrawing the validity of the ref_begin signal.

(2) Operation of reading the video memory: activated by a valid rdsdrm signal. First, the video memory controller 4 enters into ACT_RD (Active Read, a self-defined state name) state and provides an Active command to the SDRAM, to activate one or more Banks (the SDRAM is constituted by a plurality of Banks, each of which is constituted by a plurality of Rows, each Row comprising a plurality of Columns).

The row address provided by the address generator 10 in the display-driving circuit 3 is sent to the address bus of the SDRAM.

Upon expiration of the tRCD timing (the delay time between RAS to CAS, RAS referring to Row Address Strobe, CAS referring to Column Address Strobe), the video memory controller 4 enters into Read_C state (Read Command, a self-defined state name), and provides a Read command to the SDRAM, to read data from the SDRAM, wherein all column addresses being zero.

In the following CL^{th} period (CAS Latency), the read data is delivered via the SDRAM data bus.

In the next period, the video memory controller 4 provides a valid writing signal and at the same time, the address generator 10 provides the DPRAM address, and the video memory controller 4 writes the display data of one page (256 bits) from the SDRAM into the DPRAM.

After the video memory controller 4 reads all valid data in the current page, the address generator 10 provides a rd_burst_end signal (Read Burst End) and the video memory controller 4 enters into Read_PreB (a self-defined state name) state, provides a Precharge command to the SDRAM and closes the current Bank.

Then, the video memory controller 4 enters into ACT_RD state again and starts to read the display data of the second page.

After performing above processing for 4 times consecutively, a row of display data is stored into the designated page in the DPRAM and the video memory controller 4 enters into Read_D (Read Data, a self-defined state name) state, provides a rddone signal to notify the read signal generators 7 of withdrawing the valid of the rdsdrm signal.

In the above process, the video memory controller 4 won't respond to other valid signals with high priority generated during reading each page of data from the SDRAM. To perform the processing to the ref_begin signal with higher priority, the video memory controller 4 may return to IDLE state to process the ref_begin signal request (if any) at first each time reading a page of data is completed, otherwise respond to the rdsdrm signal due to its continual validity by continuing the reading operation of the next page. The time period in which the rdsdrm signal keeps valid depends on the number of consecutive operations of reading page data, which may be set by default when the embedded system withdraws the validity of the rdsdrm signal. In case of the above display with higher resolution having 1024 words in a row, the embedded system may set the number as 4 by default (256 words in a page).

(3) Operation of writing the video memory: activated by a valid fifo_nemp signal. The video memory controller 4 first enters into ReadFIFO (Read FIFO, a self-defined state name) state, provides a fifo_rd signal to the FIFO buffer so that a set of addresses, data and control words in the FIFO buffer 5 are read into the address register 12, data register 13 and video memory controller 4 respectively and the internal count in the FIFO buffer 5 decreases by 1 automatically. When the FIFO buffer 5 is empty, the fifo_nemp signal becomes invalid.

When the read data becomes constant, the video memory controller 4 enters into ACT_WR (Activate Write, a self-defined state name) state and provides an ACTIVE command to the SDRAM to activate one or more Banks and the row addresses in the address register 11 are sent to the SDRAM address bus.

Upon expiration of the trcd timing, the video memory controller 4 provides a Write command to the SDRAM and the column addresses in the address register 11 are sent to the SDRAM address bus. Tri-state gates 13 are turned ON and the video memory controller 4 sends the correct data to the SDRAM data bus according to the control word. At the same time, the video memory controller 4 (in Write_C state, a self-defined state name) outputs a corresponding DQM control signal to the SDRAM.

In s line-accelerating mode (the line-accelerating flag=1, representing to draw a line), the video memory controller 4 writes a plurality of identical data into the SDRAM consecutively till the whole line is written (Write_burst state and Write_last state, self-defined state names). Then, the video memory controller 4 enters into Write_PreB state and provides a Precharge command to terminate the writing operation and closes the current Bank.

When the line length value exceeds one page, the edge of the page may be determined with software and a long line may be divided into a plurality of shorter lines. Alternatively, this may be done with hardware, in a method similar to the above reading operation.

In a normal mode (the line-accelerating flag=0, indicating to draw a point), the video memory controller 4 will enter into Write_PreB state directly after a data is written, without performing a burst writing operation.

In the last, upon expiration of the trp (RAS Pre-charging time) timing, the video memory controller 4 returns to the IDLE state.

Similarly, the video memory controller 4 won't respond to other valid signals with high priority generated during each writing operation to the SDRAM.

The video memory 2 in the embodiments of the invention is implemented by a SDRAM, which has much lower cost than a SRAM. Further, the inherent nature of the SDRAM may contribute to writing of batch data (i.e. page burst access). Thus, the system efficiency is improved greatly.

Alternatively, the video memory 2 may use other media other than the SDRAM, such as DDR SDRAM, which won't influence the basic configuration and reading/writing strategy of the apparatus of the invention, only with slight difference in operational timming from the above embodiment. DDR and SDRAM have similar access control manner, with difference in that DDR may access data both at the rising edge and the falling edge of a clock while SDRAM can only access data at the rising edge of a clock. If the method of the invention is applied using a DDR video memory, only time sequence for accessing and refreshing the video memory 2 need to be modified, that is, to modify the state and timing constant of each branch in the video memory controller 4 shown in FIG. 8 under the control of DDR. Therefore, the above method and apparatus for accelerating the display of horizontal lines employing the video memory 2 not in form of SDRAM also falls within the protection scope claimed by the present invention.

Most of the parts in the apparatus according to above embodiments may be implemented in FPGA (Field Programmable Gate-Array) or ASIC (Application Specific Integrated Circuit), and thus have the embedded system have lower cost.

What is claimed is:

1. An apparatus for accelerating the display of horizontal lines used an embedded system, said embedded system comprising a CPU (Central Processing Unit), a display terminal, a video memory for storing one or more display data, each data corresponds to a respective pixel on said display terminal, and a display-driving circuit for generating logic signals to read said display data from said video memory and delivering said display data to said display terminal for display, said apparatus for accelerating the display of horizontal lines comprising:
a video memory controller, coupled to said CPU, said display-driving circuit and said video memory, for receiving all request signals for performing reading and writing operations with said video memory, generating respective logic signals in response to said request signals and controlling the operations of reading data from or writing data into said video memory;
a FIFO (First-In First-Out) buffer, coupled to a CPU bus, for, when said CPU provides an instruction for performing an operation of writing data into said video memory, buffering a control word sent by said CPU to said video memory controller, and said starting address for writing data into said video memory and said data to be written; and
a line-accelerating register, comprising a length register for registering a line length value from said CPU and a line-accelerating flag for indicating an instruction for displaying a point or displaying a line from said CPU, wherein said FIFO buffer is also coupled to the output of said line-accelerating register and said FIFO buffer outputs a signal indicating whether it's empty or not to said video memory controller.

2. The apparatus of claim 1, further comprises a timing-refreshing unit coupled to said video memory controller, for generating a request signal for performing a refreshing operation with said video memory at a timing, sending said request signal to said video memory controller, and withdrawing said request signal according to a response signal from said video memory controller,
wherein said video memory is SDRAM (Synchronous Dynamic Random Access Memory).

3. The apparatus of claim 1, wherein said display-driving circuit comprises a DPRAM (Dual Port RAM) for receiving data read by said video memory, said DPRAM comprising at least two pages.

4. The apparatus of claim 1, wherein each of said video memory controller, said FIFO buffer, said line-accelerating register is implemented in FPGA or ASIC.

5. A method for accelerating the display of horizontal lines by using an apparatus for accelerating the display of horizontal lines, used for an embedded system, said embedded system comprising a CPU (Central Processing Unit), a display terminal, a video memory for storing one or more display data, each data corresponds to a respective pixel on said display terminal, and a display-driving circuit for generating logic signals to read said display data from said video memory and delivering said display data to said display terminal for display, said apparatus for accelerating the display of horizontal lines comprising a video memory controller, coupled to said CPU, said display-driving circuit and said video memory, for receiving from said CPU all request signals for performing reading and writing operations with said video memory, generating respective logic signals in response to said request signals and controlling the operations of reading data from or writing data into said video memory; a FIFO (First-In First-Out) buffer, coupled to said CPU bus, for, when said CPU provides an instruction for performing an operation of writing data into said video memory, buffering a control word sent by said CPU to said video memory controller, and said starting address for said operation of writing data into said video memory and said data to be written; and a line-accelerating register comprising a length register for registering a line length value from said CPU and a line-accelerating flag for indicating an instruction for displaying a point or displaying a line from said CPU, wherein said FIFO buffer is also coupled to the output of said line-accelerating register and said FIFO buffer outputs a signal indicating whether it's empty or not to said video memory controller, said method comprising steps of:
a). generating by said display-driving circuit a valid rdsdram signal according to a timing set by said system and outputting said valid rdsdram signal to said video memory controller;
b). providing by said CPU to said FIFO buffer said starting address for writing data into said video memory and said data to be written and providing said control word by said CPU to said FIFO buffer via said line-accelerating register when said CPU generates an instruction for performing an operation of writing data into said video memory;
c). generating by said FIFO buffer a valid fifo_nemp signal and providing said valid fifo_nemp signal to said video memory controller when the data which has not been read by said video memory controller is present in said FIFO buffer; and
d). responding to said video memory by said video memory controller as follows when said video memory controller receives or detects said valid rdsdrm signal and said valid fifo_nemp signal,
(1) in case of said valid rdsdrm signal, controlling by said video memory controller the operation of reading data from said video memory according to a reading address generated by an address generator, and providing by said video memory controller a response signal so that said display-driving circuit withdraws the validity of said rdsdrm signal after said reading operation is completed; and
(2) in case of said valid fifo_nemp signal, reading by said video memory controller said FIFO buffer and controlling the operation of writing data into said video memory according to said address, data and control word,
wherein said steps a to d are not necessarily performed in a sequence.

6. The method of claim 5, wherein said apparatus for accelerating the display of horizontal lines used in an embedded system further comprises a timing-refreshing unit coupled to said video memory controller, for generating a request signal for performing a refreshing operation with said video memory at a timing, sending said request signal to said video memory controller, and withdrawing said request signal according to a response signal from said video memory controller, and wherein said video memory is SDRAM (Synchronous Dynamic Random Access Memory), said method further comprising steps of:
e). generating by said timing-refreshing unit a valid ref_begin signal and providing said valid ref_begin signal to said video memory controller; and
at said step d), further responding to said video memory by said video memory controller as follows upon receipt or detection of said valid ref_begin signal, said valid rdsdrm signal and said valid fifo_nemp signal:
(3) in case of said valid ref_begin signal, controlling a automatic refreshing operation with said video memory by said video memory controller and providing a response signal so that said timing-refreshing unit withdraws the validity of said ref_begin signal after said automatic refreshing operation is completed;
wherein said steps a) to e) are not necessarily performed in said priority order.

7. The method of claim 5, wherein said step b comprises steps of:
(b1) writing by said CPU said control word-into said line-accelerating register when said instruction for performing an operation of writing data into said video memory generated by said CPU indicates to draw a line, said control word including said line-accelerating flag (=1) and said line length value;
(b2) clearing said line-accelerating flag to zero automatically each time said step (b1) is completed, so that it is not necessary to write said control word to said line-accelerating register when said instruction for performing an operation of writing data into said video memory generated by said CPU indicates to draw a pixel,
wherein at step d), said video memory controller performs the following operations according to said line-accelerating flag in said control word on receipt or detection of said valid fifo_nemp signal:
(I). writing said data for drawing a point into said video memory according to said starting address and said data when said line-accelerating flag is 0; and
(II). writing said data for drawing a line into said video memory according to said starting address, said data and said line length value when said line-accelerating flag is 1, that is, writing a plurality of identical data in the range of said line length value into said video memory consecutively.

8. The method of claim 5, wherein, at said step d), responding to said video memory by said video memory controller based on said valid ref_begin signal, said valid rdsdrm signal and said valid fifo_nemp signal is made according to said priority of these signals.

9. The method of claim 5, wherein, at said step d), said operation of reading data from or writing data into said video memory is performed by activating a page burst access to said SDRAM as said video memory.
